(19) United States
(12) Patent Application Publication
(10) Pub. No.: US 2026/0134227 A1
(43) Pub. Date: May 14, 2026

(54) MULTI-LM ARCHITECTURE FOR TEXT GENERATION

(71) Applicant: OPTUM, INC., Minnetonka, MN (US)

(72) Inventors: Aldo Cordova Palomera, San Diego, CA (US); Maulik R. Kamdar, Roslindale, MA (US); Vijay S. Nori, Roswell, GA (US); Eran Halperin, Santa Monica, CA (US); Kevin Lee Larsen, Cheverly, MD (US)

(21) Appl. No.: 19/183,323

(22) Filed: Apr. 18, 2025

Related U.S. Application Data
(60) Provisional application No. 63/720,457, filed on Nov. 14, 2024.

(51) Int. Cl. G06F 40/40; G06N 3/0475

(52) U.S. Cl. CPC G06F 40/40; G06N 3/0475

(57) ABSTRACT

The disclosed techniques can avoid or otherwise mitigate/reduce errors or other deficiencies in automatically generated text using a multi-language model (multi-LM) architecture. The architecture includes one or more text generation LMs that generate candidate text of a desired type, and a set of validation LMs that analyze the candidate text. The disclosed techniques prompt the validation LMs to generate respective metrics indicating quality of the candidate text according to an evaluation instrument. The disclosed techniques can then determine whether to validate the candidate text based at least in part on those metrics, and either release (e.g., approve, transmit, etc.) the candidate text or refrain from releasing the candidate text accordingly. Also disclosed is an expanded multi-LM architecture that implements feedback to improve the quality of text when candidate text cannot be validated.

### CROSS-REFERENCE TO RELATED APPLICATIONS

This application claims the benefit of U.S. Provisional Patent Application No. 63/720,457, entitled “Automated Multi-agent Evaluation of LLM Generated Content” and filed on Nov. 14, 2024, the disclosure of which is hereby incorporated herein by reference in its entirety.

### TECHNICAL FIELD

The present disclosure generally relates to techniques for text generation, and more particularly, to techniques for generating text using large language models while improving text quality.

### BACKGROUND

Recently, language models (LMs) have been adopted to generate text in a wide variety of fields and use cases. However, the quality of such auto-generated text can be unreliable (e.g., due to omissions of important information, inclusion of irrelevant information, inaccuracies, hallucinations, improper weighting of various aspects of the inputs, etc.), which may be unacceptable in important or sensitive use cases, such as healthcare applications, where poor quality can lead to substantial inefficiencies, confusion, costs, and/or other negative outcomes.

### BRIEF DESCRIPTION OF THE DRAWINGS

The figures described below depict embodiments for purposes of illustration only. One skilled in the art will readily recognize from the following discussion that alternative embodiments of the systems and methods illustrated herein may be employed without departing from the principles of the disclosure described herein. The detailed description is described with reference to the accompanying figures. In the figures, the same reference number appearing in different figures indicates the same element or a similar element.

FIG. 1 depicts an example computing environment in which various embodiments of the present disclosure can be implemented.

FIG. 2 depicts an example multi-language model (multi-LM) architecture that may be implemented by the computing system of FIG. 1 to generate high-quality text.

FIG. 3 depicts an example multi-LM architecture that the computing system of FIG. 1 may implement to generate candidate text.

FIG. 4 depicts an example expanded multi-LM architecture that the computing system of FIG. 1 may implement to generate high-quality text.

FIG. 5 depicts a flow diagram of an example computer-implemented method for validating and calibrating a validation LM prior to run-time operation/production.

FIG. 6 depicts a flow diagram of an example computer-implemented method for generating high-quality text.

### DETAILED DESCRIPTION

As explained above in the Background, the quality of text generated by language models (LMs) (e.g., large language models (LLMs), natural language processing (NLP) techniques, etc.) can be unreliable due to deficiencies such as the omission of important information, the inclusion of irrelevant information, inaccuracies, hallucinations, improper weighting of various aspects of the inputs, etc. Techniques (systems, methods, processes, etc.) of the present disclosure can avoid or otherwise mitigate/reduce such errors or deficiencies. In particular, the disclosed techniques implement an architecture in which one or more text generation LMs generate candidate text of the desired type, and in which a set of one or more validation LMs analyze the candidate text. The disclosed techniques prompt the validation LM(s) to generate respective metrics indicating quality of the candidate text according to an evaluation instrument. The disclosed techniques can then determine whether to validate the candidate text based at least in part on those metrics, and either release (e.g., approve, transmit, etc.) the candidate text or refrain from releasing the candidate text accordingly.

For example, in an embodiment where the text generation LM(s) generate a candidate clinical decision support (CDS) note based on an input data set (e.g., patient profile information, patient care plan information, medication information, etc.), a set of two or more validation LMs may analyze the candidate CDS note according to a standardized evaluation instrument such as a nine-attribute Physician Documentation Quality Instrument (e.g., PDQI-9), a Progress Note Assessment and Plan Evaluation (PNAPE), or another suitable standardized or non-standardized/custom evaluation instrument. To provide the validation LMs with the context of the evaluation instrument, the validation LMs may be trained on a corpus of documents that includes at least one document that defines/specifies the evaluation instrument, or may accept as input prompts based on a prompt template that defines/specifies the evaluation instrument (e.g., with text descriptive of the evaluation instrument being included in the prompts that also instruct the validation LMs to rate or otherwise analyze the candidate text according to that evaluation instrument).

By leveraging the context of an evaluation instrument, the disclosed LM architectures can advantageously assess the quality of candidate text in a more reliable and uniform manner, thereby ensuring higher quality of validated/released output text. Moreover, the use of multiple validation LMs provides a combination of redundancy and diversity that can further ensure high quality of validated/released output text. In some embodiments, for example, the validation LMs include different types of models, and/or models of the same type but with different hyperparameters, to increase the likelihood that deficient candidate text is rejected even if one or more of the validation LMs are unable to detect the deficiencies of that candidate text individually.

The use of multiple, cooperating validation LMs may be facilitated by calibrating the validation LMs using sets of positive and negative control samples, such that the calibrated validation LMs output metrics within a normalized range common to the validation LMs. Positive control samples may include actual, historical input data sets (or summaries or other data derived therefrom), for example, while negative control samples may include versions of positive control samples that are deliberately modified/corrupted in a manner that virtually ensures that any LM-generated text will be of low quality (as assessed based on the evaluation instrument). As just one example, the disclosed techniques may calibrate some or all of the validation LMs such that the range of output metrics spans from 0 to 10 (e.g., with 0 corresponding to the metric generated based on the lowest quality of the negative control samples and 10 corresponding to the metric generated based on the highest quality of the positive control samples).

In some embodiments, prior to calibration/normalization, the disclosed techniques determine whether to validate or reject one or more validation LMs prior to run-time operation (e.g., whether to approve/release a given validation LM for use in run-time operation/production, or instead discard or modify the validation LM) based on the range/delta of output metrics generated by the respective validation LMs based on negative control samples versus positive control samples. For example, the disclosed techniques may approve/release a first validation LM that outputs metrics in a range of 3 to 8 (and then calibrate the output metrics to a normalized range such as 0 to 10, etc.) due to the delta value of 5 being greater than a threshold, but discard or refine a second validation LM that outputs metrics in only a range of 7 to 8 due to the delta value of 1 being less than the threshold. In this manner, the disclosed techniques can advantageously ensure that run-time/production processing resources are dedicated to validation LMs that are capable of better discriminating between low-quality and high-quality outputs of the text generation LM(s), and further ensure high quality of validated/released output text during run-time operation/production. Moreover, this benefit can advantageously be achieved without the need for labeled control samples (e.g., “known-good” text outputs associated with the positive control samples, etc.), the creation of which can be a costly and laborious process.

In some embodiments, the disclosed techniques implement an expanded multi-LM architecture that uses an additional, prompt modification LM when candidate text fails the validation process and is not released. In particular, the prompt modification LM may detect one or more errors associated with unvalidated or “failed” candidate text, and modify the prompt of at least one text generation LM in a manner that attempts to rectify the error(s). As used herein, the terms “error” and “deficiency” may refer to any aspect, feature, characteristic, etc. of text that tends to lower the quality of the text when properly evaluated under the evaluation instrument. In the CDS note example, for instance, the prompt modification LM may determine that a generated note received poor metrics from one or more validation LMs partly or entirely because the note failed to account for relevant patient allergy information, and in response modify a text generation LM prompt by adding the explicit instruction “Account for all patient allergies in the note.” By applying feedback in this manner, the expanded architecture can further ensure high quality of the validated/released text. In some embodiments, rather than modifying only a single-use prompt, the disclosed techniques modify a reusable prompt template based on the detected error(s). In this manner, text quality can be improved on a more persistent basis, while also reducing future processing requirements. In particular, modification of a reusable prompt template for text generation can avoid or reduce the occurrence of similar errors in future candidate text without necessitating the repeated engagement of the prompt modification LM (and associated processing operations) to correct such errors.

Of course, it should be appreciated that the advantages and technical improvements described above and elsewhere herein are not the only advantages and/or technical improvements that may be realized from the techniques described herein. Other advantages and/or technical improvements to the functioning of a computer itself or other technologies or technical fields may be apparent to one of ordinary skill in the art.

While examples discussed or shown herein refer primarily to the healthcare field, and specifically a use case in which CDS notes are generated and validated, it is understood that the disclosed techniques and embodiments can instead or additionally be applied to other fields and/or use cases that involve generating text for which quality assessments may be formalized.

### Example Computing Environment

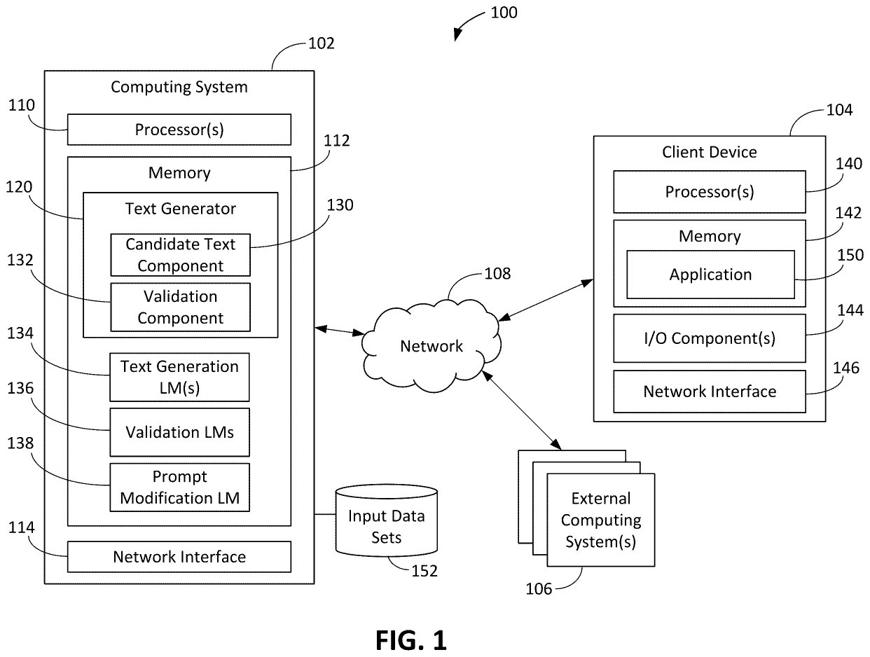

FIG. 1 depicts an example computing environment 100 in which various embodiments of the present disclosure may be implemented. Generally, the example computing environment 100 includes a computing system 102, a client device 104, and external computing systems 106, some or all of which are communicatively coupled to each other via a network 108 as shown in FIG. 1.

Generally, the client device 104 is a computing device associated with a user who may receive a particular type of text document (or message, etc.) in the regular course of operations, or in specific circumstances, in a particular field. For example, the user may be a care provider (e.g., doctor, or staff, etc.) that receives CDS notes that the user can review/consider to facilitate the planning of care paths for patients. As another example, the user may be an individual (e.g., associated with an entity that maintains/uses/etc. computing system 102) who internally reviews/approves CDS or other medical notes before the notes are transmitted, provided, etc., to an intended recipient. While FIG. 1 shows only a single client device 104, it is understood that the computing environment 100 may include any number of similar client devices associated with different users.

The computing system 102 may be associated with an organization that provides a service that includes generating notes or other text of one or more particular types (e.g., CDS notes/recommendations or other clinical notes). In some embodiments, the computing system 102 is associated with an entity that exclusively performs such a service. In other embodiments, the computing system 102 is associated with an entity such as a health insurance payor, or any other suitable entity. The computing system 102 and client device 104 may be associated with the same entity or different entities. The computing system 102 may include a single server, or multiple servers that are co-located and/or remotely distributed, for example. In some embodiments, the computing system 102 provides services via a cloud platform (e.g., Amazon Web Services (AWS)®, Microsoft Azure®, or Google Cloud®).

The computing system 102 includes one or more processors 110, memory 112, and a network interface 114. The processor(s) 110 may include any suitable number of processors and/or processor types. In some examples, the processor(s) 110 include one or more central processing units (CPUs), one or more graphics processing units (GPUs), one or more tensor processing units (TPUs), one or more field-programmable gate arrays (FPGAs), one or more application-specific integrated circuits (ASICs), and/or the like. Generally, the processor(s) 110 comprise hardware configured to execute processor-executable code/instructions stored in the memory 112.

The memory 112 may include any suitable memory type(s), including one or more volatile memories (e.g., dynamic and/or static random-access memory (RAM)) and/or non-volatile memories (e.g., read-only memory (ROM), erasable programmable ROM (EPROM), electrically EROM (EEROM), NAND flash, and/or solid state drive(s) (SSD(s))), all or any of which are examples of non-transitory, computer-readable media. In some examples, the memory 112 stores one or more of: an operating system; one or more software components (e.g., firmware, application(s), binary, source code, executable instructions, machine-learned model(s)); transient data and/or code loaded and/or operated on by one or more software component(s); and/or other suitable components/data).

In the example computing environment 100, the memory 112 stores the processor-executable instructions of a text generator application 120, which includes a candidate text component 130 and a validation component 132, as well as one or more text generation LMs 134, validation LMs 136, and a prompt modification LM 138. These components and LMs are discussed in further detail below, according to various embodiments.

In some embodiments, the text generator application 120 includes more, fewer, and/or different components, and/or the memory 112 may store more, fewer, and/or different components, than what is depicted in FIG. 1. In some embodiments, for example, the computing environment 100 does not include prompt modification LM 138, or does not include external computing system(s) 106, etc. Additionally or alternatively, in some embodiments, some or all of the components that FIG. 1 shows as being stored in memory 112 are instead stored remotely, and are remotely accessed/used by the computing system 102. For example, the computing system 102 may remotely access the functionality of the text generator application 120 (or just the functionality of the candidate text component 130, etc.) via a cloud service provided by another entity and computing system. As another example, the memory 112 may store text generator application 120 locally, but text generator application 120 may remotely access (e.g., via one or more application programming interfaces (APIs), or websites, etc.) one, some, or all of LMs 134, 136, and/or 138.

The network interface 114 includes one or more hardware and/or software components that are generally configured to enable the computing system 102 to communicate, via the network 108, with other components and/or devices of the computing environment 100, such as the client device 104 and external computing system(s) 106. To this end, the network interface 114 includes hardware and/or software that operates in accordance with at least one communication protocol of the network 108.

The network 108 includes one or more wired and/or wireless communication networks, such as a cellular network (e.g., 5G®, 4G LTE®, 3G®), a Wi-Fi® network (i.e., an IEEE 802.11 standards network), a microwave access network (e.g., WiMAX®), and/or any other suitable wide area network (WAN), local area network (LAN), personal area network (PAN), etc. As just one example, the network 108 may include both a wireless LAN such as a Wi-Fi® network and a WAN such as the Internet. In some embodiments, the network 108 includes multiple, entirely distinct/parallel networks (e.g., one or more networks for communications between computing system 102 and client device 104, and one or more separate networks for communications between computing system 102 and external computing system(s) 106, etc.).

The client device 104 may be a desktop computer, a laptop computer, a tablet device, a mobile device, a wearable device (e.g., augmented or virtual reality glasses/headsets), or any other suitable computing device. The client device 104 includes one or more processors 140, memory 142, one or more input/output (I/O) components 144, and a network interface 146. The processor(s) 140 may include any suitable number of processors and/or processor types. In some examples, the processor(s) 140 include one or more CPUs, one or more GPUs, one or more TPUs, one or more FPGAs, one or more ASICs, and/or the like. Generally, the processor(s) 140 comprise hardware configured to execute instructions (e.g., processor-executable code/instructions) stored in the memory 142. The memory 142 may include any suitable memory type(s), including one or more volatile memories (e.g., dynamic and/or static RAM) and/or non-volatile memories (e.g., ROM, EPROM, EEROM, NAND flash, and/or SSD(s)), all or any of which are examples of non-transitory computer-readable media. In some examples, the memory 142 stores one or more of: an operating system; one or more software components (e.g., firmware, application(s), binary, source code, executable instructions, machine-learned model(s)); transient data and/or code loaded and/or operated on by one or more software component(s); and/or other suitable components/data). In the example computing environment 100, the memory 142 stores the processor-executable instructions of an application 150, which may be, for example, a web browser application or a dedicated application (e.g., a CDS or other healthcare application offered/provided by an entity associated with computing system 102).

The I/O component(s) 144 include hardware and/or software that generally enables a user of client device 104 (i.e., a reviewer) to interact with the client device 104, e.g., for purposes of viewing text generated, validated, and released by text generator application 120. The I/O component(s) 144 may include one or more input components that enable a user of client device 104 to enter inputs to the client device 104 (e.g., a keyboard, a microphone, etc.), one or more output components that enable the user to perceive outputs generated by the client device 104 (e.g., a monitor/display, a speaker, a haptic feedback component, etc.), and/or one or more integrated I/O components (e.g., a touchscreen). The I/O component(s) 144 may use any suitable technology or technologies, such as LED, OLED, or LCD display technology, for example. While FIG. 1 shows client device 104 as a single component communicating (via network 108) with the computing system 102, in some implementations the components of client device 104 shown in FIG. 1 are instead divided among two or more client/user-side devices. As just one example, a pair of smart glasses may include one portion of the processor(s) 140, at least a portion of the memory 142, and a display of the I/O component(s) 144, while a smartphone may include another portion of the processor(s) 140, another portion of the memory 142, a touchscreen of the I/O component(s) 144, and the network interface 146. The smart glasses may then communicate as needed with the smartphone (e.g., via Bluetooth®) to enable the operations described herein.

The network interface 146 includes one or more hardware and/or software components that are generally configured to enable the client device 104 to communicate, via the network 108, with other components and/or devices of the computing environment 100, such as the client device 104. To this end, the network interface 146 includes hardware and/or software that operates in accordance with at least one communication protocol of the network 108.

Generally, external computing system(s) 106 may be associated with entities that create, store, maintain, and/or provide data that is operated upon by candidate text component 130 when generating candidate text. For example, external computing system(s) 106 may include computing systems that store electronic health records (EHR), electronic medical records (EMR), and/or other data/information. While not explicitly shown in FIG. 1, one, some, or all of the external computing system(s) 106 may have components (e.g., processor(s), memory, network interface, and possibly I/O component(s)) that are generally similar to computing system 102 or client device 104.

The text generator application 120 is generally configured to perform operations that generate high-quality text (e.g., text that is less likely to omit important/relevant information, less likely to include irrelevant information, less likely to include inaccuracies due to hallucinations or other causes, less likely to improperly weigh various aspects of the inputs, etc.), by using a multi-LM architecture to generate candidate text and validate (or reject) the candidate text based on an evaluation instrument. Within text generator application 120, candidate text component 130 generally processes input data sets from database 152, using text generation LM(s) 134, to generate respective items of candidate text. The database 152 may be a local store for data provided by (e.g., retrieved from) one or more of external computing system(s) 106, for example. Validation component 132 generally uses validation LMs 136 to determine whether to validate or reject each item of candidate text. In some embodiments, if the candidate text fails validation, validation component 132 uses prompt modification LM 138 to adjust the manner in which candidate text component 130 generates additional candidate text. The functionality/operation of text generator application 120 and components 130, 132 is discussed below in more detail, according to various embodiments.

### Example Multi-LM Architectures and Processes

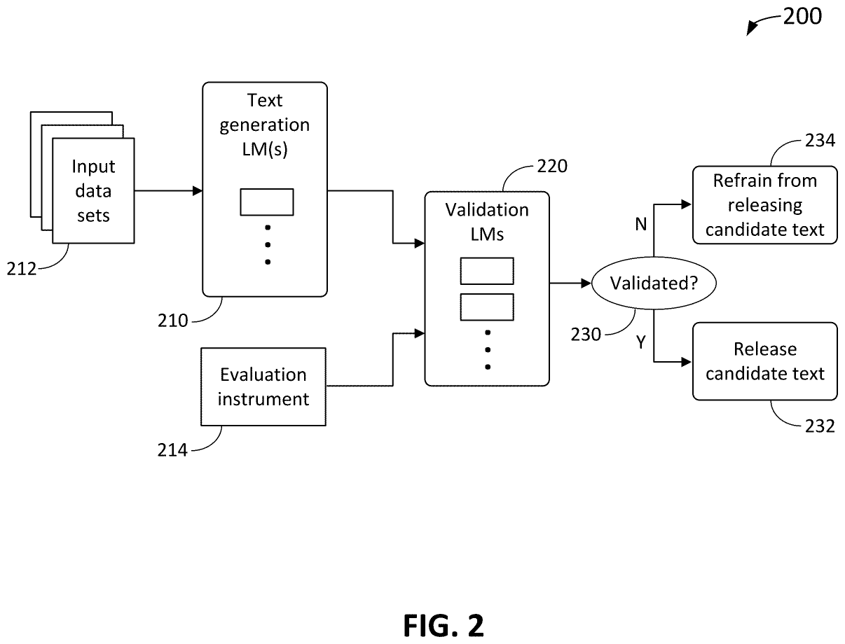

FIG. 2 depicts an example multi-LM architecture 200 that may be implemented by the computing system 102 of FIG. 1 (e.g., by processor(s) 110 when executing the instructions of text generator application 120) to generate high-quality text.

In the multi-LM architecture 200, one or more text generation LMs 210 (e.g., text generation LM(s) 134 of FIG. 1) generate items of candidate text based at least in part on respective ones of input data sets 212. A single data set of input data sets 212 may include structured data, unstructured data, or a combination of structured and unstructured data. The input data sets 212 may be provided by one or more of external computing system(s) 106 and/or locally stored in database 152, for example.

The text generation LM(s) 210 may include any suitable type or types of LM (e.g., one or more large language models (LLMs) and/or one or more small language models (SMLs)), each of which is configured to receive a text prompt (referred to herein at times as simply a “prompt”) as an input, process the text prompt, and output text responsive to the text prompt. The prompt may include the entirety of the respective input data set, a portion of the respective input data set, and/or data derived from the respective input data set (e.g., features extracted from unstructured data, etc.). In some embodiments, one or more of the text generation LM(s) 210 are multimodal LMs that operate upon text and also other types of content that may be in the input data sets (e.g., images, audio, etc.). One, some, or all of the text generation LM(s) 210 may have transformer-based model architectures that comprise an encoder that tokenizes the input and determines embeddings for the tokens, and a decoder that generates the output text based at least in part on the embeddings. The transformer model may incorporate self-attention and/or cross-attention mechanisms to facilitate more accurate output. In some embodiments, such a transformer-based machine-learned model may include different configurations of self- and/or cross-attention, followed by neural network(s) (e.g., feedforward layer(s)), recurrent layer(s), aggregation layer(s) (e.g., using softmax, matrix multiplication, and/or other aggregation techniques), and/or the like. The text generation LM(s) 210 may include one or more general-purpose models (e.g., trained on a wide array of publicly available datasets such as web pages, documents, etc., available via the Internet) such as a generative pre-trained transformer (GPT) or bi-directional encoder representations from transformers (BERT), or may be a domain-specific model (e.g., trained and/or fine-tuned on custom and/or proprietary datasets), such as a general purpose LM trained on input data sets of a sort similar to input data sets 212 and corresponding text outputs known to be of high and/or low quality.

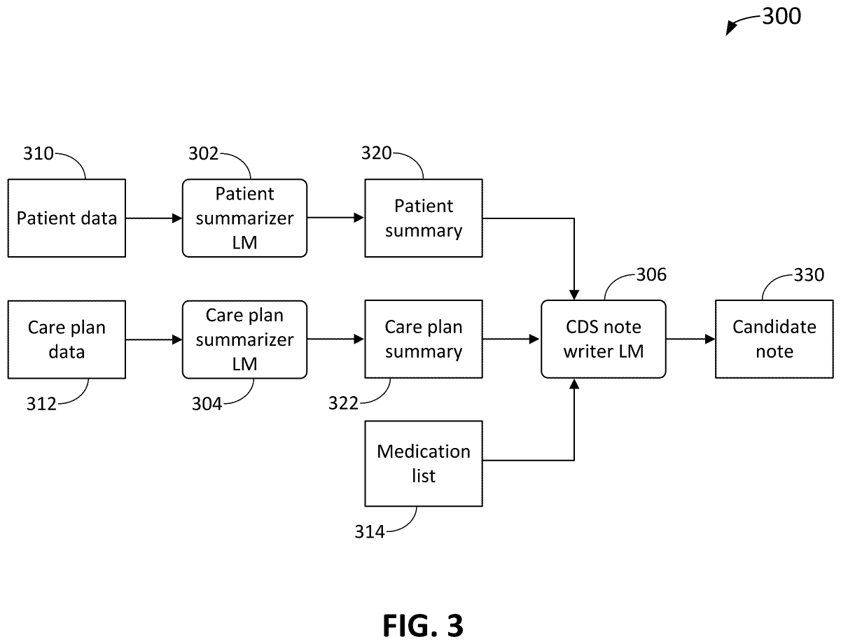

The text generation LM(s) 210 may consist of only a single LM or may include multiple LMs arranged in parallel and/or in series. A more specific architecture of text generation LM(s) 210 is discussed below in connection with FIG. 3, according to one example embodiment.

Validation generation LMs 220 (e.g., validation LMs 136 of FIG. 1) analyze/assess items of candidate text in accordance with an evaluation instrument 214. In particular, each of the validation LMs 220 is configured/trained to output a metric (e.g., score, rating, etc.) for a given input (i.e., a given item of candidate text) based on the evaluation instrument 214. Generally, the evaluation instrument 214 can be any structured framework for assessing (rating, scoring, etc.) text of the sort that is generated by text generation LM(s), and may include quantitative and/or qualitative criteria. For example, the evaluation instrument 214 may be a PDQI-9 evaluation instrument in embodiments where the generated text is a CDS note/recommendation. The PDQI-9 evaluation instrument specifies that a clinical note should be rated or scored on a scale from 1 to 5 (5 being best) with respect to each of nine different attributes: (1) whether the note is up-to-date (i.e., contains the most recent test result recommendations); (2) whether the note is accurate (i.e., is true and free of incorrect information); (3) whether the note is thorough (i.e., is complete and documents all of the issues of importance to the patient; (4) whether the note is useful (i.e., is extremely relevant, providing valuable information and/or analysis); (5) whether the note is organized (i.e., is well-formed and structured in a way that helps the reader understand the patient's clinical course); (6) whether the note is comprehensible (i.e., is clear, without ambiguity or sections that are difficult to understand); (7) whether the note is succinct (i.e., is brief, to the point, and without redundancy); (8) whether the note is synthesized (i.e., reflects an understanding of the patient's status and ability to develop a plan of care); and (9) whether the note is internally consistent (i.e., no part of the note ignores or contradicts any other part of the note). PDQI-9 also specifies that a total score is a sum of all attribute-specific scores.

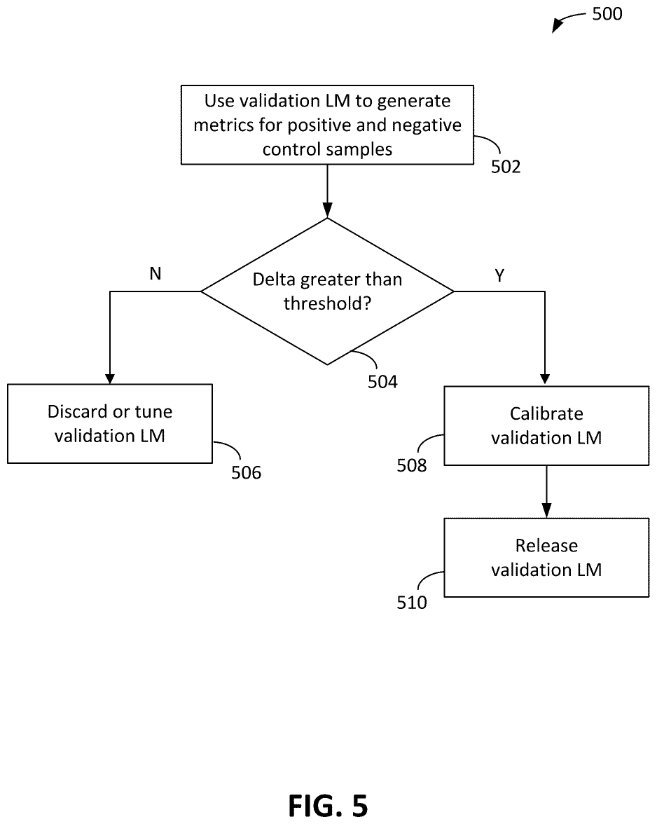

In other examples, the evaluation instrument 214 may be any other suitable type of standardized evaluation instrument (e.g., a PNAPE evaluation instrument, or a QNOTE evaluation instrument, etc.), or may be a non-standardized (e.g., custom) evaluation instrument. The validation LMs 220 may have been subject to validation and/or calibration processes prior to inclusion in a production version of the multi-LM architecture 200 (e.g., as discussed below in connection with FIG. 5).

The validation LMs 220 may include any suitable type or types of LM (e.g., one or more LLMs and/or one or more SMLs), each of which is configured to receive a prompt as an input, process the text prompt, and output text responsive to the text prompt. The prompt may include the entirety of the respective item of candidate text and additional information to instruct the respective one of the validation LMs. One, some, or all of the validation LMs 220 may have transformer-based model architectures that comprise an encoder that tokenizes the input and determines embeddings for the tokens, and a decoder that generates the output text based at least in part on the embeddings. The transformer model may incorporate self-attention and/or cross-attention mechanisms to facilitate more accurate output. In some embodiments, such a transformer-based machine-learned model may include different configurations of self- and/or cross-attention, followed by neural network(s) (e.g., feedforward layer(s)), recurrent layer(s), aggregation layer(s) (e.g., using softmax, matrix multiplication, and/or other aggregation techniques), and/or the like. The validation LMs 220 may include one or more general-purpose models (e.g., trained on a wide array of publicly available datasets such as web pages, documents, etc., available via the Internet) such as a generative GPT or BERT, or may be a domain-specific model (e.g., trained and/or fine-tuned on custom and/or proprietary datasets), such as a general purpose LM trained on text inputs and corresponding output metrics (scores, ratings, etc.) that are known to be accurate. In an alternative embodiment, the validation LMs 220 instead only include a single validation LM.

The validation LMs 220 learn the context of the evaluation instrument 214 by one or more mechanisms. In some embodiments, for example, one, some, or all of the validation LMs 220 are trained (e.g., by computing system 102 or another computing system) to apply the evaluation instrument 214, e.g., by including text associated with (descriptive of) the evaluation instrument 214 in the corpus of documents and/or other data upon which those LM(s) are trained or fine-tuned. In other embodiments, one, some, or all of the validation LMs 220 apply the evaluation instrument 214 due to the validation component 132 including text associated with (descriptive of) the evaluation instrument 214, or a link to such text, in the prompt that instructs the respective LM to assess (rate, score, etc.) the candidate text according to the evaluation instrument 214.

In some embodiments, the validation LMs 220 may be arranged in any suitable manner (e.g., serial and/or parallel arrangements of LMs), but include at least two parallel paths for providing separate (e.g., independent) assessments of a given item of candidate text (e.g., of a given CDS note/recommendation). In some embodiments, for example, the validation LMs 220 include N LMs arranged in parallel (N being an integer greater than one), with each LM receiving a prompt that (1) includes the same candidate text item (and possibly includes/specifies the evaluation instrument 214) and (2) instructs the LM to assess the candidate text item according to the evaluation instrument 214.

In some embodiments, the validation LMs 220 provide greater diversity by including at least two different types of models that assess the same candidate text. For example, the validation LMs 220 may include a GPT-3.5 model, a GPT-4 model, and a GPT-40 model to assess the same candidate text. As another example, the validation LMs 220 may include GPT, Llama®, and Mistral® models. Additionally or alternatively, the validation LMs 220 may include two or more of the same type of model but with different hyperparameters (e.g., model size, batch size, decoding type, temperature, etc.). In still other embodiments, some or all of the validation LMs 220 are of the same type and are configured with the same hyperparameters, and diversity/variety of assessments/output metrics is a function of the randomness/variety inherent to the operation of the validation LMs 220 (e.g., if the validation LMs 220 have a relatively high temperature hyperparameter setting).

In a process 230, the validation component 132 determines whether to validate/approve a given item of candidate text based at least in part on the metrics (scores, ratings, etc.) generated by different ones of the validation LMs 220. Validation component 132 may make this determination in various different ways, depending on the embodiment. In some embodiments, for example, validation component 132 computes a composite metric (e.g., an average or a sum) based on the metrics output by the validation LMs 220, and validates the candidate text if and only if the composite metric satisfies (e.g., is above) a predetermined threshold. In another example embodiment, validation component 132 uses a voting mechanism, and validates or rejects the candidate text based at least in part on a count of how many of the metrics output by the validation LMs 220 are above a predetermined threshold. In some embodiments, the determination at process 230 is based on multiple metrics output by each of one, some, or all of the validation LMs 220 (e.g., in embodiments where the validation component 132 separately accounts for each of the nine attribute scores specified by the PDQI-9 evaluation instrument, rather than accounting only for the total score). Generally, any suitable rule, algorithm, framework, etc., may be used by validation component 132 at process 230 to make a validation determination based on (at least) the metrics generated by the validation LMs 220.

When the validation component 132 validates an item of candidate text at process 230, the text generator application 120 releases the candidate text at a process 232. The process 232 includes releasing the candidate text to at least one computing device or at least one user. For example, the process 232 may include transmitting the candidate text (or a link to the candidate text) to client device 104, adding the candidate text to information that is accessible/viewable by a user of client device 104 via application 150, setting a permission flag to allow the client device 104 (and/or a user accessing a particular user account) to access/view the candidate text, and so on.

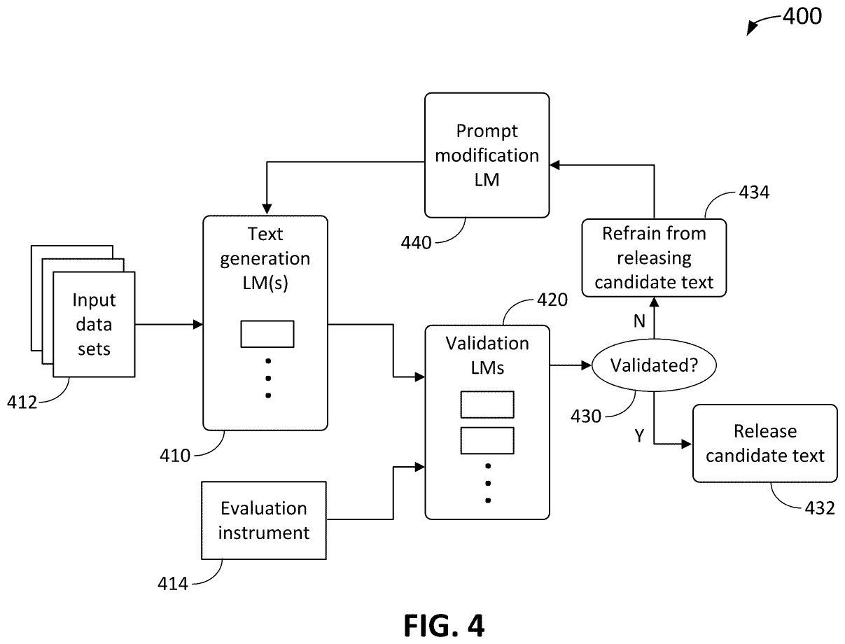

When the validation component 132 determines to not validate (e.g., determines to reject) an item of candidate text at process 230, the text generator application 120 refrains from releasing the candidate text to the computing device(s) or user(s) at a process 234. For example, the process 234 may include discarding/deleting the candidate text, ignoring the candidate text, and/or taking remedial/corrective action to generate additional, higher quality text (e.g., as discussed below in connection with FIG. 4).

FIG. 3 depicts an example multi-LM architecture 300 that the computing system 102 of FIG. 1 may implement specifically to generate candidate text. The text generation LM(s) 134 of FIG. 1 or the text generation LM(s) 210 of FIG. 2 may be arranged as the LMs 302, 304, 306 shown in FIG. 3, for example.

In the example of FIG. 3, the text generator application 120 is configured to generate CDS notes, and the candidate text component 130 uses a patient summarizer LM 302, a care plan summarizer LM 304, and a CDS note writer LM 306. In this example, a single input data set (e.g., one of input data sets 212) includes patient data 310 for a particular individual/patient, as well as care plan data 312 and a medication list 314 for that patient (or for a particular diagnosis associated with that patient, etc.). The patient summarizer LM 302 processes the patient data 310 along with other prompt information that instructs the patient summarizer LM 302 to summarize the patient data 310 as a patient summary 320, and the care plan summarizer LM 304 processes the care plan data 312 along with other prompt information that instructs the care plan summarizer LM 304 to summarize the care plan data 312 as a care plan summary 322.

In one example embodiment, prompt templates for the patient summarizer LM 302, care plan summarizer LM 304, and CDS note writer LM 306 (referred to below as Template 1, Template 2, and Template 3, respectively), are as follows:

Template 1

″″″\
′Fragment 1′ below, within triple backticks, corresponds to the medical background of a patient,
from a FHIR-formatted JSON file. \
Extract the patient history, and show it to a medical audience. \
Consider all medically-relevant details (including the patient's profile), and do not write back
internal id information the like patient name or id numbers.
Fragment 1: ‘‘‘{frag1}‘‘‘
″″″

Template 2

″″″\
′Fragment 2′ below, within triple backticks, corresponds to a patient care plan, extracted from a
FHIR-formatted JSON format file. \
It consists of a list (called here an ′initial input list′), in which each element is a nested list
structure that contains actions (indexed by the key ″action″), \
which can either be nested (as a list of dictionaries) or be terminal items (as a single dictionary).
\
Actions marked with the subfield ″′url″: ″http://ENTER URL HERE″, ″valueBoolean″: False′
should be omitted. \
The nested list structure, indicating dependencies in a hierarchy of actions (medications), should
always be considered when reading and interpreting the care plan. \
In the ′initial input list′, elements are sorted so that the first one (a nested list) is the medical
background to the second one (another nested list), the second one is the medical background to
the third one, and so on.
Prepare a text overview for a doctor, incorporating the information about medications in
′Fragment 2′.
In your summary, try to consider those points:
- Remember that this is an extract of a FHIR-formatted JSON file, and it follows FHIR
conventions.
- Just use the information available in the provided input, don't incorporate your own external
medical knowledge.
- Do not write back internal id information the like patient name or id numbers.
Fragment 2: ‘‘‘{frag2}‘‘‘
″″″

Template 3

″″″\
′Fragment 1′ below, the first markdown snippet within triple backticks, corresponds to the
medical profile of a patient. \
′Fragment 2′ below, the second markdown snippet within triple backticks, corresponds to a
generic care plan suggested for the patient in ′Fragment 1′. \
′Fragment 3′ below, the third markdown snippet within triple backticks, corresponds to a list of
medications selected by a medical provider, to treat the patient described in ′Fragment 1′.
Prepare a brief text summary for a doctor, explaining how the medications in ′Fragment 3′ can
be \
relevant to the patient described in ′Fragment 1′. \
You are encouraged to use the data from the care plan (′Fragment 2′) to articulate your answer.
In your summary, consider these points:
- Highlight how the patient's condition relates to the selected medications.
- Highlight what the selected medications have in common and in what they differ, especially
regarding known risks and benefits.
- Do not incorporate your own external medical knowledge (just use the information available in
the provided documents).
- Do not include mechanisms of action for the selected medications.
- Do not include final generic advice like ′It is important to consider the patient's medical
history...′ or ′It is important to discuss these risks′, etc.
- Do not include internal id information like ′Patient 122221 has...′ (use just ′The patient′
instead, or simply omit it).
Fragment 1: ‘‘‘{frag1}‘‘‘
Fragment 2: ‘‘‘{frag2}‘‘‘
Fragment 3: ‘‘‘{frag3}‘‘‘
″″″

In some embodiments, the patient data 310 and care plan data 312 are structured data, such as Fast Healthcare Interoperability Resources (FHIR), JavaScript Object Notation (JSON) files. In such embodiments, the prompts to LMs 302 and 304 may specify that the respective input data is in FHIR-JSON format (and possibly other detail, such as whether the FHIR-JSON data includes nested lists). This can be helpful in embodiments where the LMs 302 and 304 can recognize and parse the FHIR-JSON structure based on their training.

The patient data 310 may include data representing historical information associated with the patient, possibly including one or more attributes of the patient himself/herself. For example, the patient data 310 may include data representing patient demographic information (e.g., age, gender, ethnicity), patient weight, historical events (e.g., procedures) associated with the patient, traits of the patient, current medications of the patient, current allergies and/or other intolerances of the patient, historical conditions/diagnoses/etc. of the patient, and/or any other relevant or potentially relevant characteristics or other information associated with the patient. The care plan data 312 may include data representing a care plan (e.g., treatment plan) for the patient, such as a care plan that is currently in progress, for example.

In the example of FIG. 3, the CDS note writer LM 306 jointly processes the patient summary 320, the care plan summary 322, and the medication list 314, along with other prompt information that instructs the CDS note writer LM 306 to generate a CDS note/recommendation based on the inputs. The medication list 314 may be a list of one or more medications that will or may be prescribed to the patient (e.g., medication(s) that would be prescribed using CDS guidance, possibly via an interactive user interface), or a standard set of medications for a particular diagnosis of the patient, for example. Based on the inputs/prompt, the CDS note writer LM 306 generates a candidate CDS note 330, which is then analyzed/assessed by validation component 132 LMs (e.g., added to prompts input to the validation LMs 220 within the multi-LM architecture 200). The candidate CDS note 330 may include a proposed care plan for the patient (e.g., proposed procedure(s), proposed lab test(s), and/or proposed medication(s)), for example. In some embodiments, the prompt to CDS note writer LM 306 instructs that the CDS note be presented in a Subjective-Objective-Assessment-Plan (SOAP) format.

FIG. 4 depicts an example expanded multi-LM architecture 400 that the computing system 102 of FIG. 1 may implement to generate high-quality text. The multi-LM architecture 400 is similar to the multi-LM architecture 200 of FIG. 2, but includes a feedback mechanism to automatically improve the quality of candidate text generated by the text generation LM(s). In the multi-LM architecture 400, the text generation LM(s) 410, input data sets 412, evaluation instrument 414, and validation LMs 420 may be the same as or similar to input data sets 212, evaluation instrument 214, and validation LMs 220, respectively, of FIG. 2, and the processes 430, 432, and 434 may be the same as or similar to the processes 230, 232, and 234, respectively, of FIG. 2.

At process 434, however, the validation component 132 (or another component of text generator application 120 or another application) not only refrains from releasing the candidate text, but also instructs/prompts at a prompt modification LM 440 (e.g., prompt modification LM 138 of FIG. 1) to modify (e.g., revise, or create anew) a prompt to one or more of the text generation LM(s) 410. The prompt modification LM 440 may include any suitable type of LM, and is configured to receive a prompt as an input, process the text prompt, and output text responsive to the text prompt. The prompt modification LM 440 may have transformer-based model architectures that comprise an encoder that tokenizes the input and determines embeddings for the tokens, and a decoder that generates the output text based at least in part on the embeddings. The transformer model may incorporate self-attention and/or cross-attention mechanisms to facilitate more accurate output. In some embodiments, such a transformer-based machine-learned model may include different configurations of self- and/or cross-attention, followed by neural network(s) (e.g., feedforward layer(s)), recurrent layer(s), aggregation layer(s) (e.g., using softmax, matrix multiplication, and/or other aggregation techniques), and/or the like. The prompt modification LM 440 may be a general-purpose model (e.g., trained on a wide array of publicly available datasets such as web pages, documents, etc., available via the Internet) such as a generative GPT or BERT, or may be a domain-specific model (e.g., trained and/or fine-tuned on custom and/or proprietary datasets), such as a general purpose LM trained on prompt inputs and corresponding text prompt outputs that are known to be superior to the text prompt inputs. It is understood that, in some embodiments, an architecture of multiple prompt modification LMs may be used to modify the prompt(s) to one or more of the text generation LM(s) 410.

In some embodiments, the validation component 132 generates an additional, “feedback” prompt that includes the candidate text that was rejected in process 430, and also includes instructions to (1) detect errors in the candidate text and (2) modify (e.g., revise or create anew) prompts to one or more of text generation LM(s) 410. In some embodiments, the feedback prompt specifically instructs the prompt modification LM 440 to detect errors with respect to specific attributes or categories (e.g., any of the nine attributes that PDQI-9 specifies for assessing a note). The feedback prompt may also include the text of the prompt(s) that were used by one or more of the text generation LM(s) 410 when generating the rejected candidate text. The validation component 132 applies the feedback prompt as input to prompt modification LM 440, which in response outputs the modified (i.e., revised or new) prompt(s) for one or more of the text generation LM(s) 410.

With reference to the example embodiment of FIG. 3, the prompt modification LM 440 may generate a modified prompt for the CDS note writer LM 306, the patient summarizer LM 302, and/or the care plan summarizer LM 304. For example, the prompt modification LM 440 may determine that a generated CDS note failed validation at process 430 partly or entirely because the CDS note failed to account for patient allergy information. The prompt modification LM 440 may therefore modify a prompt to the CDS note writer LM 306 by adding the explicit instruction “Account for all patient allergies in the note.” As another example, the prompt modification LM 440 may determine that a generated CDS note failed validation at process 430 partly or entirely because the CDS note was not sufficiently up to date (e.g., failed to properly account for a recent test result). The prompt modification LM 440 may therefore modify a prompt to the CDS note writer LM 306 and/or a prompt to the patient summarizer LM 302 by adding the explicit instruction “The note should generally stress the importance of more recent occurrences over older occurrences” and/or “The summary should generally stress the importance of more recent occurrences over older occurrences”, respectively.

In some embodiments, the prompt modification LM 440 modifies a reusable prompt template rather than only an individual, single-use prompt. In the preceding example, for instance, the prompt modification LM 440 may modify a reusable prompt template used by validation component 132 to generate multiple future prompts to the CDS note writer LM 306, by adding to the prompt template the explicit instruction “The note should generally stress the importance of more recent occurrences over older occurrences.”

While FIG. 4 shows one particular embodiment that incorporates feedback, other types of automated and/or manual feedback are also possible when candidate text is not validated at block 430. For example, instead of (or in addition to) automatically modifying a text generation prompt (or reusable prompt template) as described above, a user may review the metric(s) output by the validation LMs 420, and provide/generate feedback by manually modifying one or more of the text generation LM(s) 410 (e.g., changing hyperparameters or model types) and/or modifying a prompt or reusable prompt template for one or more of the text generation LM(s) 410.

### Example Computer-Implemented Methods

FIG. 5 depicts a flow diagram of an example computer-implemented method 500 for validating and calibrating a validation LM, such as one of validation LMs 136, 220, or 420, prior to the inclusion of that validation LM for run-time operation/production. For case of explanation, the method 500 is described with reference to an embodiment in which the method 500 is performed by processor-executable instructions of text generator application 120 when executed by processor(s) 110. In other embodiments, however, the method 500 is performed by another application and/or another computing system.

At block 502 of the method 500, the text generator application 120 uses the validation LM under consideration to generate metrics (e.g., scores, ratings, etc.) for a set of one or more positive control samples and a set of one or more negative control samples (i.e., when using the respective sets of control samples as input to the validation LM). In some embodiments, each of one, some, or all of the positive control samples represent actual, historical information (e.g., historical patient information similar to that shown in FIG. 3), and each of one, some, or all of the negative control samples is a deliberately corrupted version of a positive control sample. With reference to the example embodiment of FIG. 3, for example, one negative control sample may include patient data (similar to patient data 310) for a first patient and care plan data (similar to care plan data 312) for a different, second patient, or include patient data and care plan data for a first patient with a medication list (similar to medication list 314) for a different, second patient, etc. As an alternative example, a portion of the care plan data 312 may be modified or omitted, etc.

In some embodiments, negative and positive control samples include intermediate text (e.g., summaries) produced by a portion of text generation LM(s) 134. For example, one negative control sample (representing a relatively low level of data corruption) may include a care plan summary (e.g., similar to summary 322) for Patient 1 diagnosed with diabetes, a patient summary (e.g., similar to summary 320) for a different Patient 2 also diagnosed with diabetes, and a list of medications that are standard medications to treat diabetes in Patient 1. Another example negative control sample, however, may represent a higher level of data corruption by including a care plan summary for Patient 1 diagnosed with diabetes, a patient summary for Patient 3 diagnosed with neurodegeneration, and a list of medications that are standard medications to treat diabetes in Patient 1.

At block 504, the text generator application 120 determines whether a delta/gap between metrics output by the validation LM with the positive control sample(s) and metrics output by the validation LM with the negative control sample(s) exceeds a threshold. In embodiments where multiple positive control samples and multiple negative control samples are used at block 502, block 504 may include computing a first metric (e.g., average or sum) based on the metrics that the validation LM outputs with the positive control samples and computing a second metric (e.g., average or sum) based on the metrics that the validation LM outputs with the negative control samples, and determining whether the delta between the first and second metrics exceeds the threshold. In other embodiments, block 504 computes the delta based on a “most corrupted” negative control sample (e.g., the above example in which summaries are taken from patients with very different diagnoses) and one or more positive control samples. In some embodiments, block 504 also includes one or more other validation operations, such as determining whether a gradual degradation of negative control samples (e.g., progressively more corrupted relative to positive control samples) is properly reflected by a gradual degradation of metrics output by the validation LM.

If the delta is not greater than the threshold (and/or if other validation operations are unsuccessful), flow proceeds to block 506 and the text generator application 120 discards the validation LM or tunes/refines the validation LM (or, in other embodiments, the validation LM is manually tuned/refined). If the delta is greater than the threshold (and/or if other validation operations are successful), however, flow instead proceeds to block 508 and the text generator application 120 calibrates the validation LM based on the delta. For example, in an embodiment where the threshold is set to 5, the text generator application 120 may proceed to calibrate the validation LM at block 508 if the metrics for the negative and positive control samples range from 2 to 9 (delta=7), and instead discard or further tune (e.g., modify the prompt and/or hyperparameters for) the validation LM at block 506 if those metrics instead range from 2 to 5 (delta=3), or from 6 to 10 (delta=4), etc.

The calibrating at block 508 may include normalizing the output range of the validation LM to match a common/shared range that is to be used for some or all of the validation LMs 136, 220, or 420 used in run-time operation/production, for example. For instance, in the noted example where the output metric range is 2 to 9, the output may be scaled and shifted to instead be 0 to 10, 1 to 10, 0 to 100, or any other suitable range that is to be shared by the final set of validation LMs. It is understood that references herein to calibrating or normalizing a validation LM encompass embodiments in which the validation LM itself is modified, as well as embodiments in which the validation LM is not itself modified but inputs and/or outputs of the validation LM are modified (e.g., by changing language of a prompt template to request mathematical operations on an output score or rating, or by applying one or more post-processing operations that scale, shift, or otherwise transform the metrics output by the validation LM, etc.).

At block 510, the text generator application 120 releases the (normalized) validation LM for run-time operation/production, e.g., as one of validation LMs 136, 220, or 420. Block 510 may include, for example, transmitting the parameters (weights, tokenization library, etc.) of the validated and calibrated validation LM to a run-time server of computing system 102, setting a flag or data field value to indicate run-time engagement of the validation LM, and/or other operation(s) that cause the computing system 102 to use the validation LM as one of validation LMs 136, 220, or 420.

In some embodiments and/or scenarios, the text generator application 120 or other application repeats the method 500 for each of one, some, or all of the validation LMs used in run-time operation (e.g., each of validation LMs 136, 220, or 420 as well as any discarded validation LMs), and/or repeats the method 500 for a single validation LM as the validation LM is iteratively tuned/refined.

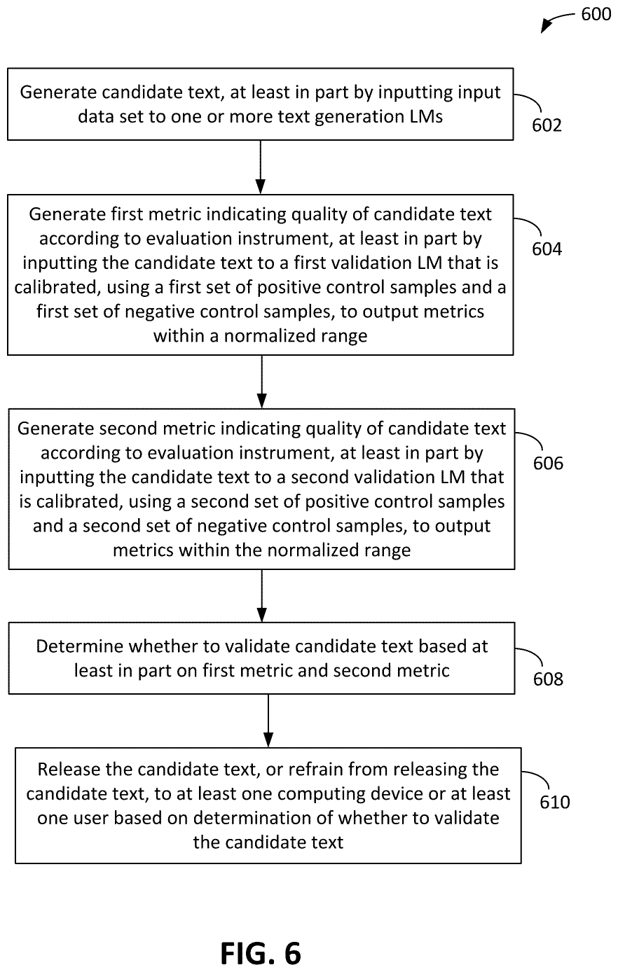

FIG. 6 depicts a flow diagram of an example computer-implemented method 600 for generating high-quality text. For ease of explanation, the method 600 is described with reference to an embodiment in which the method 600 is performed by processor-executable instructions of text generator application 120 when executed by processor(s) 110. In other embodiments, however, the method 600 is performed by another application and/or another computing system.

At block 602, the text generator application 120 generates candidate text (e.g., a proposed CDS note), at least in part by inputting an input data set (e.g., one of input data sets 212 of FIG. 2, a data set comprising elements 310, 312, and 314 of FIG. 3, or one of input data sets 412 of FIG. 4) to one or more text generation LMs (e.g., LM(s) 134 of FIG. 1, LMs 210 of FIG. 2, LMs 302, 304, and 306 of FIG. 3, or LMs 410 of FIG. 4).

At block 604, the text generator application 120 generates a first metric indicating quality of the candidate text according to an evaluation instrument (e.g., a standardized evaluation instrument such as PDQI-9, PNAPE, QNOTE, etc., or a custom evaluation instrument, etc.), at least in part by inputting the candidate text to a first validation LM (e.g., one of validation LMs 136, 220, or 420) that is calibrated, using a first set of positive control samples and a first set of negative control samples, to output metrics within a normalized range (e.g., calibrated using the method 500 or a similar method).

At block 606, the text generator application 120 generates a second metric indicating quality of the candidate text according to the same evaluation instrument, at least in part by inputting the candidate text to a second validation LM (e.g., a different one of validation LMs 136, 220, or 420) that is calibrated, using a second set of positive control samples and a second set of negative control samples, to output metrics within a normalized range (e.g., calibrated using the method 500 or a similar method). The first and second sets of positive control samples may be the same sets, entirely different sets, or partially overlapping sets of control samples. Similarly, the first and second sets of negative control samples may be the same sets, entirely different sets, or partially overlapping sets of control samples

At block 608, the text generator application 120 determines, based at least in part on the first metric and the second metric (and possibly also additional metrics output by the first and/or second validation LM, and/or metric(s) output by one or more additional validation LMs), whether to validate the candidate text. Block 608 may use a thresholding technique, a voting technique, or any other suitable technique or combination of techniques to determine whether to validate the candidate text. Block 608 may be similar to process 230 or 430, for example.

At block 610, the text generator application 120 either (1) when determining to validate the candidate text at block 608, releases the candidate text to at least one computing device (e.g., client device 104) or at least one user (e.g., a user of client device 104), or (2) when determining to not validate the candidate text at block 608, refrains from releasing the candidate text to the at least one computing device or the at least one user. The releasing may be similar to process 232 or 432, and the refraining from releasing may be similar to process 234 or 434, for example.

It is understood that the operations of the method 600 may be performed in any suitable order (e.g., with blocks 604 and 606 occurring in parallel), and/or may include fewer, additional, or different operations, in various embodiments. In an alternative embodiment, for example, only a single validation LM is used (i.e., block 606 is omitted, and block 608 modified so as to not make use of the second metric).

### EXAMPLES

Example 1. A computer-implemented method comprising: generating, by one or more processors, candidate text, at least in part by inputting an input data set to one or more text generation language models (LMs); generating, by the one or more processors, a first metric indicating quality of the candidate text according to an evaluation instrument, at least in part by inputting the candidate text to a first validation LM that is calibrated, using a first set of positive control samples and a first set of negative control samples, to output metrics within a normalized range; generating, by the one or more processors, a second metric indicating quality of the candidate text according to the evaluation instrument, at least in part by inputting the candidate text to a second validation LM that is calibrated, using a second set of positive control samples and a second set of negative control samples, to output metrics within the normalized range; determining, by the one or more processors and based at least in part on the first metric and the second metric, whether to validate the candidate text; when determining to validate the candidate text, releasing, by the one or more processors, the candidate text to at least one computing device or at least one user; and when determining to not validate the candidate text, refraining, by the one or more processors, from releasing the candidate text to the at least one computing device or the at least one user.

Example 2. The computer-implemented method of Example 1, wherein one or both of: a model type of the first validation LM differs from a model type of the second validation LM; and hyperparameters of the first validation LM differs from hyperparameters of the second validation LM.

Example 3. The computer-implemented method of Example 1 or 2, wherein determining whether to validate the candidate text includes: computing a composite metric based at least in part on the first metric and the second metric; and determining whether to validate the candidate text based at least in part on the composite metric.

Example 4. The computer-implemented method of Example 1 or 2, wherein determining whether to validate the candidate text includes determining whether to validate the candidate text based at least in part on a count of how many validation LMs generated a metric above a threshold.

Example 5. The computer-implemented method of any one of Examples 1-4, comprising: when determining to not validate the candidate text, modifying, based at least in part on one or both of the first metric and the second metric, one or both of (i) at least one LM of the one or more text generation LMs, and (ii) a prompt or a reusable prompt template for the at least one LM.

Example 6. The computer-implemented method of any one of Examples 1-4, comprising: when determining to not validate the candidate text, modifying, by the one or more processors, a prompt or a reusable prompt template for at least one LM of the one or more text generation LMs, wherein modifying the prompt or the reusable prompt template for the at least one LM includes using a prompt modification LM to (i) detect one or more errors associated with the candidate text, and (ii) modify the prompt or the reusable prompt template for the at least one LM based on the one or more errors.

Example 7. The computer-implemented method of any one of Examples 1-6, comprising: validating, by the one or more processors, the first validation LM based at least in part on a delta between (i) metrics output by the first validation LM when processing one or more samples of the first set of positive control samples and (ii) metrics output by the first validation LM when processing one or more samples of the first set of negative control samples.

Example 8. The computer-implemented method of any one of Examples 1-7, wherein the first validation LM is trained at least in part on text associated with the evaluation instrument.

Example 9. The computer-implemented method of any one of Examples 1-7, wherein generating the first metric includes (i) generating a prompt that includes the candidate text and text associated with the evaluation instrument, and (ii) inputting the prompt to the first validation LM.

Example 10. The computer-implemented method of any one of Examples 1-8, wherein the input data set is associated with an individual, and wherein the candidate text specifies a proposed procedure for the individual.

Example 11. The computer-implemented method of Example 10, wherein the input data set includes data indicative of one or more attributes of the individual.

Example 12. The computer-implemented method of Example 10 or 11, wherein the input data set includes data indicative of one or both of: one or more historical procedures associated with the individual; and one or more medications.

Example 13. The computer-implemented method of any one of Examples 1-12, comprising: calibrating, by the one or more processors, the first validation LM, at least in part by inputting the first set of positive control samples and the first set of negative control samples to the first validation LM; and calibrating, by the one or more processors, the second validation LM, at least in part by inputting the second set of positive control samples and the second set of negative control samples to the second validation LM.

Example 14. The computer-implemented method of Example 13, wherein: the first set of positive control samples includes the first set of positive control samples includes one or more input data sets; and the first set of negative control samples includes corrupted versions of the one or more input data sets.

Example 15. A computer-implemented method comprising: generating, by one or more processors, candidate text, at least in part by inputting an input data set to one or more text generation language models (LMs); generating, by the one or more processors, a metric indicating quality of the candidate text according to an evaluation instrument, at least in part by inputting the candidate text to a validation LM that is calibrated, using a set of positive control samples and a set of negative control samples, to output metrics within a normalized range; determining, by the one or more processors and based at least in part on the metric, whether to validate the candidate text; when determining to validate the candidate text, releasing, by the one or more processors, the candidate text to at least one computing device or at least one user; and when determining to not validate the candidate text, refraining, by the one or more processors, from releasing the candidate text to the at least one computing device or the at least one user.

Example 16. A system comprising: one or more processors; and one or more memories storing processor-executable instructions that, when executed by the one or more processors, cause the one or more processors to perform operations comprising the computer-implemented method of any one of Examples 1-15.

Example 17. One or more non-transitory, computer-readable media storing processor-executable instructions that, when executed by one or more processors, cause the one or more processors to perform operations comprising the computer-implemented method of any one of Examples 1-15.

### ADDITIONAL CONSIDERATIONS

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., enreviewer-only model(s), enreviewer-dereviewer model(s), dereviewer-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112 (f) unless traditional means-plus-function language is expressly recited, such as “means for” or “step for” language being explicitly recited in the claim(s).

What is claimed is:

1. A computer-implemented method comprising:
generating, by one or more processors, candidate text, at least in part by inputting an input data set to one or more text generation language models (LMs);
generating, by the one or more processors, a first metric indicating quality of the candidate text according to an evaluation instrument, at least in part by inputting the candidate text to a first validation LM that is calibrated, using a first set of positive control samples and a first set of negative control samples, to output metrics within a normalized range;
generating, by the one or more processors, a second metric indicating quality of the candidate text according to the evaluation instrument, at least in part by inputting the candidate text to a second validation LM that is calibrated, using a second set of positive control samples and a second set of negative control samples, to output metrics within the normalized range;
determining, by the one or more processors and based at least in part on the first metric and the second metric, whether to validate the candidate text;
when determining to validate the candidate text, releasing, by the one or more processors, the candidate text to at least one computing device or at least one user; and
when determining to not validate the candidate text, refraining, by the one or more processors, from releasing the candidate text to the at least one computing device or the at least one user.

2. The computer-implemented method of claim 1, wherein one or both of:
a model type of the first validation LM differs from a model type of the second validation LM; and
hyperparameters of the first validation LM differs from hyperparameters of the second validation LM.

3. The computer-implemented method of claim 1, wherein determining whether to validate the candidate text includes:
computing a composite metric based at least in part on the first metric and the second metric; and
determining whether to validate the candidate text based at least in part on the composite metric.

4. The computer-implemented method of claim 1, wherein determining whether to validate the candidate text includes determining whether to validate the candidate text based at least in part on a count of how many validation LMs generated a metric above a threshold.

5. The computer-implemented method of claim 1, comprising:
when determining to not validate the candidate text, modifying, based at least in part on one or both of the first metric and the second metric, one or both of (i) at least one LM of the one or more text generation LMs, and (ii) a prompt or a reusable prompt template for the at least one LM.

6. The computer-implemented method of claim 1, comprising:
when determining to not validate the candidate text, modifying, by the one or more processors, a prompt or a reusable prompt template for at least one LM of the one or more text generation LMs,
wherein modifying the prompt or the reusable prompt template for the at least one LM includes using a prompt modification LM to (i) detect one or more errors associated with the candidate text, and (ii) modify the prompt or the reusable prompt template for the at least one LM based on the one or more errors.

7. The computer-implemented method of claim 1, comprising:
validating, by the one or more processors, the first validation LM based at least in part on a delta between (i) metrics output by the first validation LM when processing one or more samples of the first set of positive control samples and (ii) metrics output by the first validation LM when processing one or more samples of the first set of negative control samples.

8. The computer-implemented method of claim 1, wherein the first validation LM is trained at least in part on text associated with the evaluation instrument.

9. The computer-implemented method of claim 1, wherein generating the first metric includes (i) generating a prompt that includes the candidate text and text associated with the evaluation instrument, and (ii) inputting the prompt to the first validation LM.

10. The computer-implemented method of claim 1, wherein the input data set is associated with an individual, and wherein the candidate text specifies a proposed procedure for the individual.

11. The computer-implemented method of claim 10, wherein the input data set includes data indicative of one or more attributes of the individual.

12. The computer-implemented method of claim 10, wherein the input data set includes data indicative of one or both of:
one or more historical procedures associated with the individual; and
one or more medications.

13. The computer-implemented method of claim 1, comprising:
calibrating, by the one or more processors, the first validation LM, at least in part by inputting the first set of positive control samples and the first set of negative control samples to the first validation LM; and
calibrating, by the one or more processors, the second validation LM, at least in part by inputting the second set of positive control samples and the second set of negative control samples to the second validation LM.

14. The computer-implemented method of claim 13, wherein the first set of negative control samples includes corrupted versions of the first set of positive control samples.

15. A system comprising:
one or more processors; and
one or more memories storing processor-executable instructions that, when executed by the one or more processors, cause the one or more processors to perform operations comprising:
generating candidate text, at least in part by inputting an input data set to one or more text generation language models (LMs);
generating a first metric indicating quality of the candidate text according to an evaluation instrument, at least in part by inputting the candidate text to a first validation LM that is calibrated, using a first set of positive control samples and a first set of negative control samples, to output metrics within a normalized range;
generating a second metric indicating quality of the candidate text according to the evaluation instrument, at least in part by inputting the candidate text to a second validation LM that is calibrated, using a second set of positive control samples and a second set of negative control samples, to output metrics within the normalized range;
determining, based at least in part on the first metric and the second metric, whether to validate the candidate text;
when determining to validate the candidate text, releasing the candidate text to at least one computing device or at least one user; and
when determining to not validate the candidate text, refraining from releasing the candidate text to the at least one computing device or the at least one user.

16. The system of claim 15, wherein one or both of:
a model type of the first validation LM differs from a model type of the second validation LM; and
hyperparameters of the first validation LM differs from hyperparameters of the second validation LM.

17. The system of claim 15, wherein the operations comprise:
when determining to not validate the candidate text, modifying, based at least in part on one or both of the first metric and the second metric, one or both of (i) at least one LM of the one or more text generation LMs, and (ii) a prompt or a reusable prompt template for the at least one LM.

18. The system of claim 15, wherein:
the operations comprise, when determining to not validate the candidate text, modifying a prompt or a reusable prompt template for at least one LM of the one or more text generation LMs; and
modifying the prompt or the reusable prompt template for the at least one LM includes using a prompt modification LM to (i) detect one or more errors associated with the candidate text, and (ii) modify the prompt or the reusable prompt template for the at least one LM based on the one or more errors.

19. The system of claim 15, wherein the operations comprise:
validating the first validation LM based at least in part on a delta between (i) metrics output by the first validation LM when processing one or more samples of the first set of positive control samples and (ii) metrics output by the first validation LM when processing one or more samples of the first set of negative control samples.

20. One or more non-transitory, computer-readable media storing processor-executable instructions that, when executed by one or more processors, cause the one or more processors to perform operations comprising:
generating candidate text, at least in part by inputting an input data set to one or more text generation language models (LMs);
generating a first metric indicating quality of the candidate text according to an evaluation instrument, at least in part by inputting the candidate text to a first validation LM that is calibrated, using a first set of positive control samples and a first set of negative control samples, to output metrics within a normalized range;
generating a second metric indicating quality of the candidate text according to the evaluation instrument, at least in part by inputting the candidate text to a second validation LM that is calibrated, using a second set of positive control samples and a second set of negative control samples, to output metrics within the normalized range;
determining, based at least in part on the first metric and the second metric, whether to validate the candidate text;
when determining to validate the candidate text, releasing the candidate text to at least one computing device or at least one user; and
when determining to not validate the candidate text, refraining from releasing the candidate text to the at least one computing device or the at least one user.
